(19) United States
(12) Patent Application Publication
(10) Pub. No.: US 2015/0242625 A1
(43) Pub. Date: Aug. 27, 2015

(54) Pre-Delegation of Defined User Roles for Guiding User in Incident Response

(71) Applicant: Cybersponse, Inc., Scottsdale, AZ (US)

(72) Inventors: Craig Cassidy, Phoenix, AZ (US); Christopher Coriale, Phoenix, AZ (US)

(21) Appl. No.: 14/630,383

(22) Filed: Feb. 24, 2015

Related U.S. Application Data
(60) Provisional application No. 61/943,564, filed on Feb. 24, 2014.

(51) Int. Cl. G06F 21/55; G06F 17/30

(52) U.S. Cl. CPC G06F 21/554; G06F 17/30876

(57) ABSTRACT

Incident response systems may benefit from proper organization and handling of responses. For example, incident response systems may benefit from the pre-delegation of defined user roles for guiding one or more users in an incident response. A method can include monitoring, by a computer system, an incident. The method can also include determining, by the computer system, whether each of a plurality of incident response team members is checked in with respect to the incident. The method can further include maintaining, by the computer system, a set of task lists and role type assignments based on the determination.

### CROSS-REFERENCE TO RELATED APPLICATION

This application is related to and claims the benefit and priority of U.S. Provisional Application No. 61/943,564, filed Feb. 24, 2014, the entirety of which is hereby incorporated herein by reference.

### BACKGROUND

1. Field

Incident response systems may benefit from proper organization and handling of responses. For example, incident response systems may benefit from the pre-delegation of defined user roles for guiding one or more users in an incident response.

2. Description of the Related Art

Being the victim of a cyber attack is a highly stressful and disruptive event for the operations of any entity. Many organizations do not have incident response plans in place to handle such a disruption. Those that do have incident response plans generally have them to varying degrees of detail. The most effective response plans contain enough detail that the incident response team will know exactly what to do in the event of virtually any incident.

However, because of the high stress and chaos that ensues during an actual incident, even the best plans are often forgotten, ignored, or ineffectually executed due to confusion. Many organizations attempt to counter this by practicing response drills and creating exhaustive written instructions for different types of incidents. These approaches may result in varying degrees of success, but an all-too-common problem persists: in the heat of the moment, human responders still lose track of their roles and instructions.

Organizations preparing for cyber attacks simply do not have the resources to undertake military-like reinforcement of these principles with their information technology, executive, public relations, and other personnel.

For further discussion of cyber security, see U.S. Provisional Patent Application No. 61/799,882, filed Mar. 15, 2013, of Michael Zduniak et al., the entirety of which is hereby incorporated herein by reference.

### SUMMARY

According to certain embodiments, an apparatus can include at least one processor and at least one memory including computer program code. The at least one memory and the computer program code can be configured to, with the at least one processor, cause the apparatus at least to monitor an incident. The at least one memory and the computer program code can also be configured to, with the at least one processor, cause the apparatus at least to determine whether each of a plurality of incident response team members is checked in with respect to the incident. The at least one memory and the computer program code can further be configured to, with the at least one processor, cause the apparatus at least to maintain a set of task lists and role type assignments based on the determination.

In certain embodiments, a method can include monitoring, by a computer system, an incident. The method can also include determining, by the computer system, whether each of a plurality of incident response team members is checked in with respect to the incident. The method can further include maintaining, by the computer system, a set of task lists and role type assignments based on the determination.

An apparatus, according to certain embodiments, can include at least one processor and at least one memory including computer program code. The at least one memory and the computer program code can be configured to, with the at least one processor, cause the apparatus at least to determine whether a first time limit for performing an assigned task is past, and when it is determined that the first time limit is past, send an electronic notification that the time limit is past. The at least one memory and the computer program code can also be configured to, with the at least one processor, cause the apparatus at least to determine whether a second time limit for performing the assigned task is past, and when it is determined that the second time limit is past, send a second notification to a first higher tier of support. The at least one memory and the computer program code can further be configured to, with the at least one processor, cause the apparatus at least to determine whether a third time limit for performing the assigned task is past, and when it is determined that the third time limit is past, send a third notification to a second higher tier of support and assign a fallback task to mitigate nonperformance of the assigned task.

A method, in certain embodiments, can include determining, by a computer system, whether a first time limit for performing an assigned task is past, and when it is determined that the first time limit is past, sending an electronic notification that the time limit is past. The method can also include determining, by the computer system, whether a second time limit for performing the assigned task is past, and when it is determined that the second time limit is past, sending a second notification to a first higher tier of support. The method can further include determining, by the computer system, whether a third time limit for performing the assigned task is past, and when it is determined that the third time limit is past, sending a third notification to a second higher tier of support and assign a fallback task to mitigate nonperformance of the assigned task.

According to certain embodiments, a system for guiding an incident response team member to respond to an incident can include a computer having a processor and a database coupled to the computer. The system can also include a non-transitory processor-readable storage medium coupled to the computer and storing executable instructions configured to retrieve from the database a role type of the incident response team member based on the incident and retrieve from the database an assigned task list of the role type. The executable instructions can also be configured to notify and present to the incident response team member the assigned task list and monitor a participation status of the incident response team member and update the participation status to the database. The executable instructions can further be configured to monitor an incident status of the incident and update the incident status to the database and close the incident after the incident has been resolved.

### BRIEF DESCRIPTION OF THE DRAWINGS

For proper understanding of the invention, reference should be made to the accompanying drawings, wherein:

FIG. 1 is a process flow diagram illustrating a basic workflow for defining role types, according to certain embodiments of the present invention.

FIG. 2 is a process flow diagram illustrating a basic workflow for assigning incident response (IR) team members to role types, according to certain embodiments of the present invention.

FIG. 3 is a process flow diagram illustrating an automated process for assigning IR team members to incident types based on their role type, according to certain embodiments of the present invention.

FIG. 4 is a process flow diagram illustrating automated generation of task lists for individual IR team members, according to certain embodiments of the present invention.

FIG. 5 is a process flow diagram illustrating an automated check in procedure for IR team members, according to certain embodiments of the present invention.

FIG. 6 is a process flow diagram illustrating an automated process to monitor the status of IR team members and update other IR team members' task lists in the event of one or more IR team members being unable to participate, according to certain embodiments of the present invention.

FIG. 7 illustrates a computer system, according to certain embodiments of the present invention.

FIG. 8 illustrates escalation handling according to certain embodiments of the present invention.

### DETAILED DESCRIPTION

Certain embodiments of the present invention relate to a method and system for pre-delegating roles and responsibilities for cyber security incident response teams in a concise and easy-to-understand format. This pre-delegation technique may greatly reduce confusion during an incident by automatically directing individual response team members to their roles and responsibilities. This will help ensure that the roles designated during incident response planning are maintained during an actual incident.

An embodiment is a secure collaboration system designed to facilitate computer security incident response. The secure collaboration system can be a standalone platform. However, it can include both receiving and sending capabilities to work with other security products/systems.

One function of the secure collaboration system can be to identify important events and quickly mobilize the right people to handle these events. The term “security event” or just “event,” as used herein can refer to data about an observable occurrence in a system or network with a potentially negative consequence, coming from a single source, that must be evaluated to determine if responsive action is necessary. Events can include system crashes, packet floods, unauthorized use of system privileges, unauthorized access to sensitive data, denial of service attacks, unauthorized code modifications, policy violations, virus infections, and execution of malware.

Similarly, the term “security incident” or just “incident” can refer to a set of one or more related security events that, to protect the network or system, have been determined to require responsive action by personnel.

Certain embodiments of the present invention may be a part of a larger incident response scheme or system, wherein event data is received by both external and internal sources. This event data can be processed to determine whether an incident has occurred. If the event data is elevated to incident status, the secure collaboration system can notify incident response team personnel so they can be mobilized for response.

Certain embodiments of the present invention may provide an easy to utilize command-and-control structure during a response. Moreover, certain embodiments of the present invention may reduce confusion during an incident by automatically directing individual response team members to their roles and responsibilities. Furthermore, certain embodiments of the present invention may ensure that the roles designated during incident response planning are maintained during an actual incident.

Certain embodiments more particularly relate to a method and system for pre-delegating roles and responsibilities for cyber security incident response teams, guiding the team members to perform their duties in response to an incident, monitoring the participation of the team members and the status of the incident, and automatically adjusting the roles of the team members when some required roles are missing.

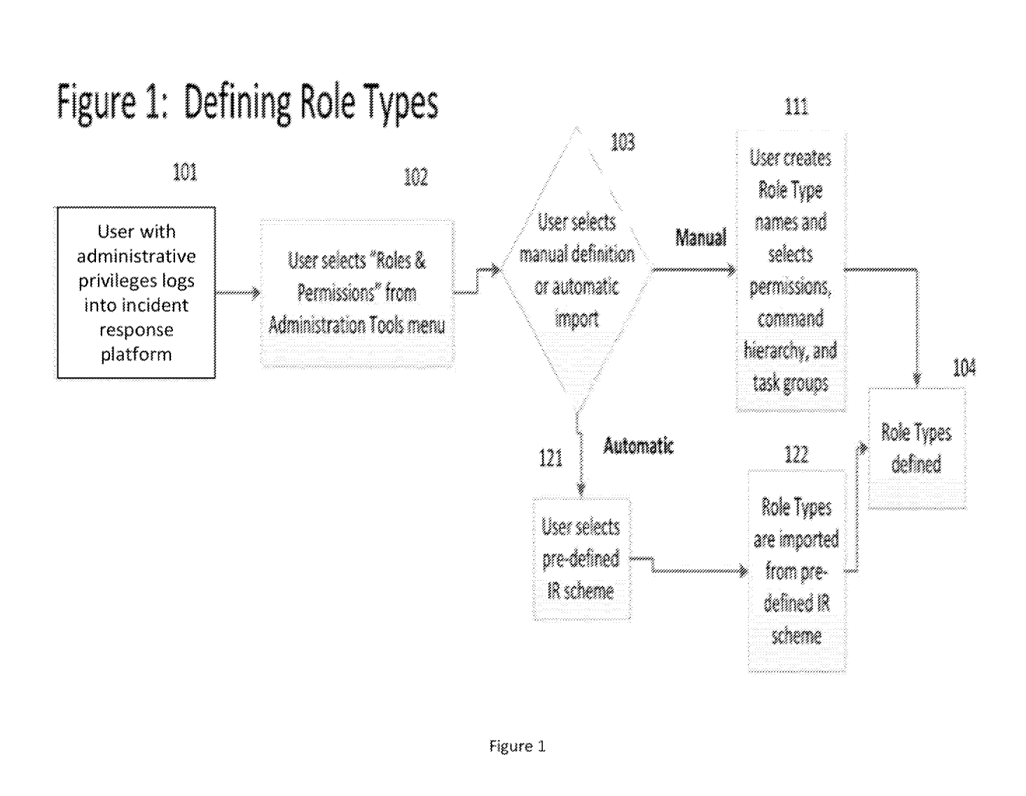

FIG. 1 shows a high level overview of the basic process of a secure collaboration system for defining role types, according to certain embodiments of the present invention. The term “role types” can refer to data sets that contain user permissions, command hierarchy information, task groups, and may include other information specific to a user role.

As shown in FIG. 1, in step 101, an administrator can log into the incident response platform. From the on-screen menus, the administrator may select a menu option labeled “Roles & Permissions” from a list of administrator tools as demonstrated in 102. At this point, in 103, the administrator may have the choice of manually defining role types or automatically importing them from a pre-defined standard. This pre-defined standard may be ISO, NIST, an internal company standard, or any other pre-defined list already loaded into the system that has defined role types.

If the user selects to manually define role types as in 111, he may be presented with a variety of options. The administrator can first assign a unique name to each role type that the administrator chooses to create. Then, the administrator may select permissions for each role type including what information that role type has access to, what other types of users that role type may communicate with, and many other defined permissions. The administrator may also select what communication methods a specific role type may utilize or be contacted with. For example, an administrator may choose to limit communications for less-essential IR team members to email, while setting more critical members to receive phone calls and text messages as well. In defining a role type, the administrator may also set a command hierarchy for the role type. This can be analogized to military ranks as a higher setting can mean that this role type will have more responsibility for coordination of the response. The command hierarchy setting can be there to ensure that someone is available to monitor the overall incident and coordinate on-the-fly. Another selection that the administrator may make in the manual role type setting is the task group assigned to a role type. A task group can refer to a list of tasks that the role type is either authorized or expected to perform if the need arises. Task groups may either be pre-defined or set manually themselves. Some examples of task groups can include checking equipment, monitoring network traffic, checking infrastructure, handling public relations, coordinating with law enforcement, and a variety of other tasks that may need to be performed during an incident.

If the administrator chooses to automatically define role types, as in 121, the administrator can simply choose a response scheme from a menu. These schemes can be pre-defined either based on industry standards or internal procedures already codified in a configuration file. When the administrator chooses to automatically define role types in this way, the role types can automatically be populated from the pre-defined scheme, as shown in 122. At the end of this process, the role types for the secure collaboration system may now be defined, as illustrated at 104.

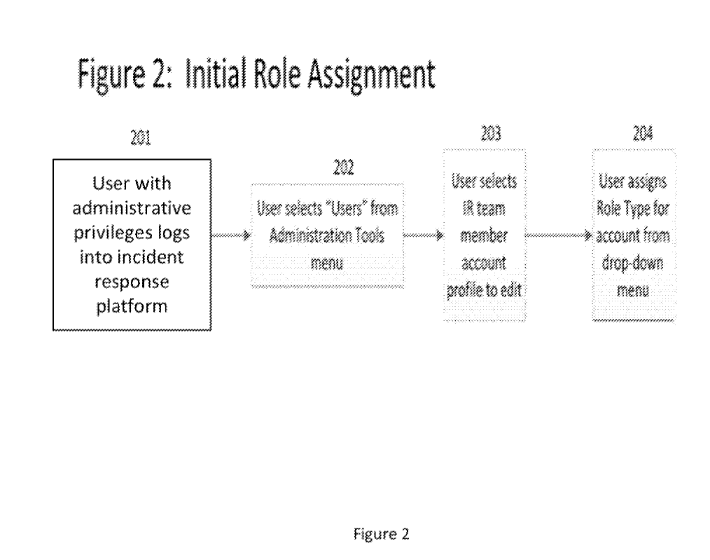

FIG. 2 illustrates a basic process of initial role assignment according to certain embodiments of the present invention. An administrator can log into the system, as in 201. Then the administrator can select a “Users” option from an Administration Tools menu, shown in 202. Next the administrator can select an IR team member's account name and may be able to edit the profile of the IR team member 203. Finally, in 204, the administrator can assign an individual IR team member a specific role type from a drop down menu within the IR team member's account profile.

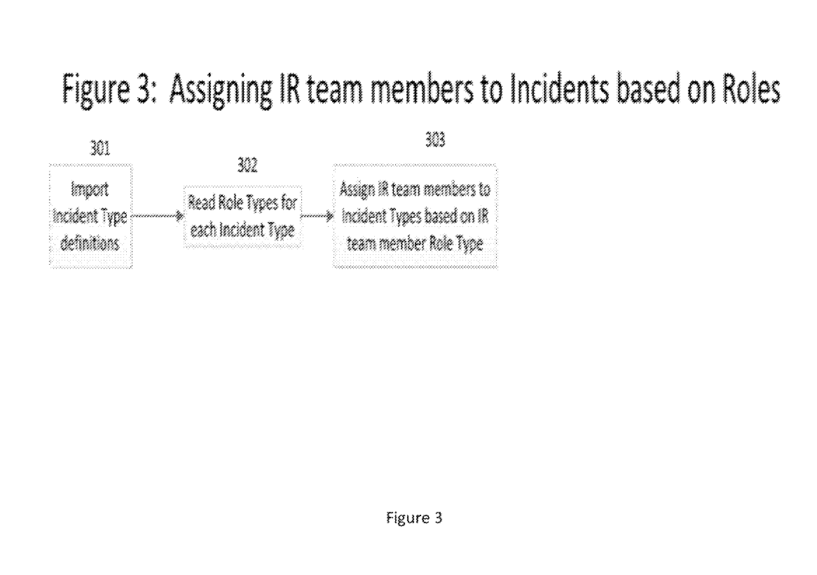

FIG. 3 is a basic workflow of certain embodiments of the present invention for ensuring that different incident types have the proper personnel assigned to them. The term “incident type” can refer to the type of security incident that is in need of response. There can be many incident types, including DDoS attacks, power outages, viruses, unauthorized access, and many other incidents. Incident types can be pre-defined in a configuration file or other library file and can include a definition of the incident, the proper role types to respond to it, and a task list that provides instructions for remediation of the incident.

As shown in FIG. 3, at 301, an incident type definitions file can be imported. Next, in 302, the incident type definition file can be read by the system to determine what role types should be assigned. Finally, in 303, the IR team members that have been assigned the role types for each specific incident type can be assigned to the same incident type.

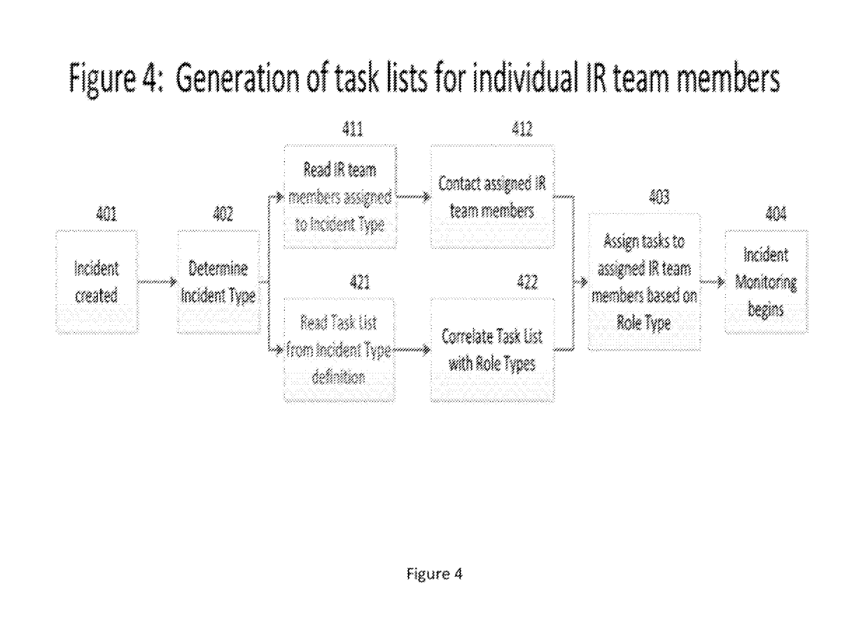

FIG. 4 demonstrates the generation of task lists for individual IR team members as they respond to an incident implemented in certain embodiments of the present invention. The first step, in 401, may rely on the creation of an “incident” report within the system. Generally, an incident can be created after event data has been analyzed by either a human or an automated system. Once an event or collection of events have been classified as an incident, the system can determine the incident type. In 402, the system can analyze the event and/or incident data to determine the incident type. Oftentimes, the incident type information can be contained in the incoming event or incident data. A human may also analyze the incoming event or incident data and manually determine the incident type.

After the incident type has been determined, the IR team members assigned to that incident type can be contacted, as illustrated in 411 and 412.

Simultaneously, the incident type definition file can be read to find the corresponding task list, as in 421. Next, this task list can be correlated with role types in 422.

After the IR team members assigned to the incident type are contacted and the task list is correlated with role types, the tasks from the task list can be assigned to the IR team members assigned to the incident type with the corresponding role types. This is demonstrated in 403. Finally, after the tasks have been properly assigned, the incident monitoring process can begin in 404.

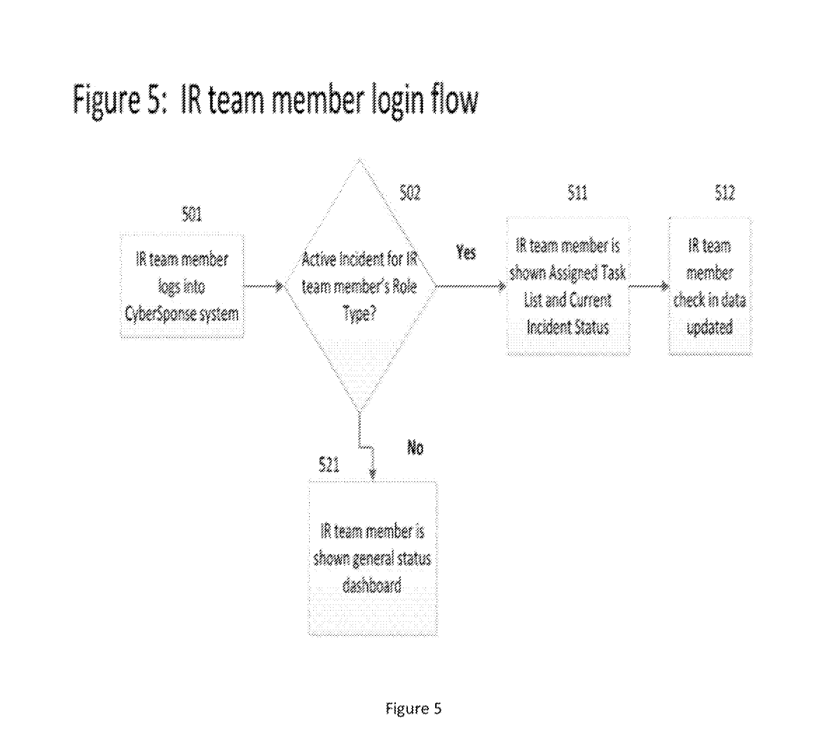

FIG. 5 represents part of a standard process by which all IR team members can log into the system. The illustrated process demonstrates some of the steps of monitoring of IR team member participation. After an IR team member logs into the system in 501, the system can check to see if that IR team member has been assigned to an active incident in 502. If the IR team member has been assigned to an active incident, the IR team member can be shown the Assigned Task list for that team member's role type and the current incident status, as demonstrated in 511. At this point, the IR team member can be considered “checked in” and the team member's check in data can be updated to reflect this in 512.

Check in data may also be updated manually. For example, it may be possible for an IR team member to access the secure collaboration system while nevertheless be unable to perform the team member's assigned tasks. In a case such as this, the IR team member may change the team member's check in data to reflect that that team member is not participating in the response.

If the IR team member is not assigned to an active incident, the team member can be taken to the standard general status dashboard for the system. 521.

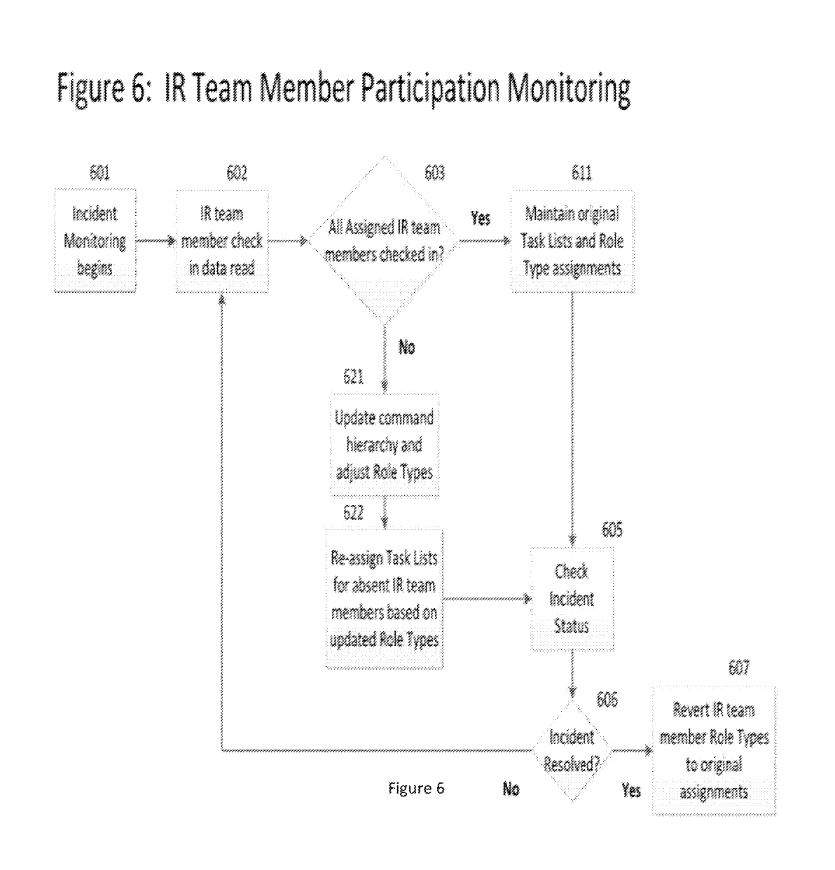

FIG. 6 demonstrates an IR team member participation monitoring cycle, according to certain embodiments of the present invention. Once incident monitoring begins, in 404 and 601, the IR team member check in data can be read automatically by the system in 602. The system can then check to see if all of the assigned IR team members are checked in to the incident in 603. If they are, the system can keep all IR team members assigned to their original task lists and role type assignments in 611. The system can then proceed to recheck the incident status, to determine whether the incident has been resolved as well as to determine progress on the task lists in 605.

If fewer than all of the members of the assigned IR team are checked in, the system can update the command hierarchy and automatically adjust the assigned role types for the checked in IR team members to ensure that all required role types for the response are represented. This update and adjustment can takes place in step 621. The updating of the command hierarchy can be a process that may elevate the next-highest ranking IR team member, if a higher-ranking IR team member is not participating in the response. The system can ensure that there is always a participating IR team member with the highest command hierarchy designation. This can ensure that there is always someone in charge and capable of making decisions during a response.

Furthermore, illustrated in 622, in the event that a required role type is not participating, the system can temporarily adjust participating IR team members' role types to ensure that all assigned tasks from all task lists are assigned and visible to participating IR team members. In this way, the system can ensure that no required response task is overlooked. The reassignment of role types may be done either automatically according to pre-determined rules or adjusted manually by a participating IR team member with the highest command hierarchy value. The system can then proceed to recheck the Incident Status in 605.

After 605, the system can check to see if the incident has been resolved in 606. If the incident has not been resolved, the system can begin the monitoring loop again at 602. If the incident has been resolved, the system can revert all IR team member role types and command hierarchy values to their original assignments in 607 and close the incident. An incident may also be manually marked as resolved by the participating IR team member with the highest command hierarchy value.

During a second or subsequent loop through, in 603 the system can check whether any new IR team members have checked in or checked out, compared with a previous iteration. If not, the procedure may continue to 611, but if there have been any check in changes, the system can proceed to 621.

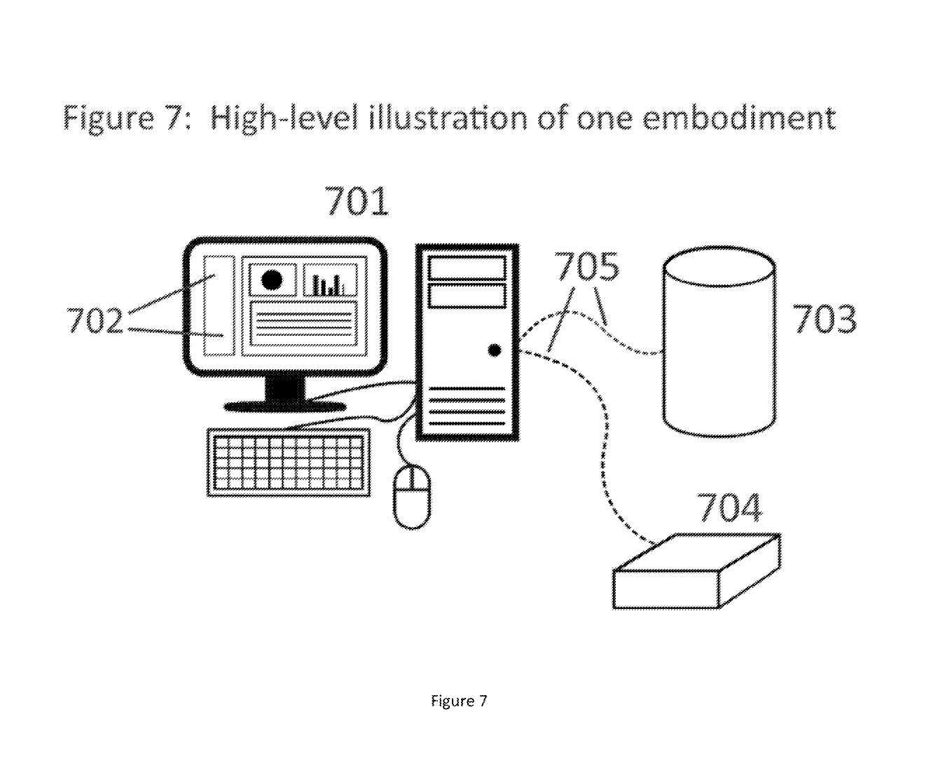

FIG. 7 illustrates, at a high level, a system according to certain embodiments of the present invention. Element 701 shows a computer having a processor and a screen. Element 702 represents where a user interface (UI) could be displayed on the screen. Element 703 represents one or more databases where role types, task lists, user information, response schemes, incident types, check in data, incident status, and other data to be used by the system may be stored. Element 704 represents a non-transitory processor-readable storage medium in which can be stored executable instructions for the previously described processes. Element 705 represents the communication routes between the components in this figure.

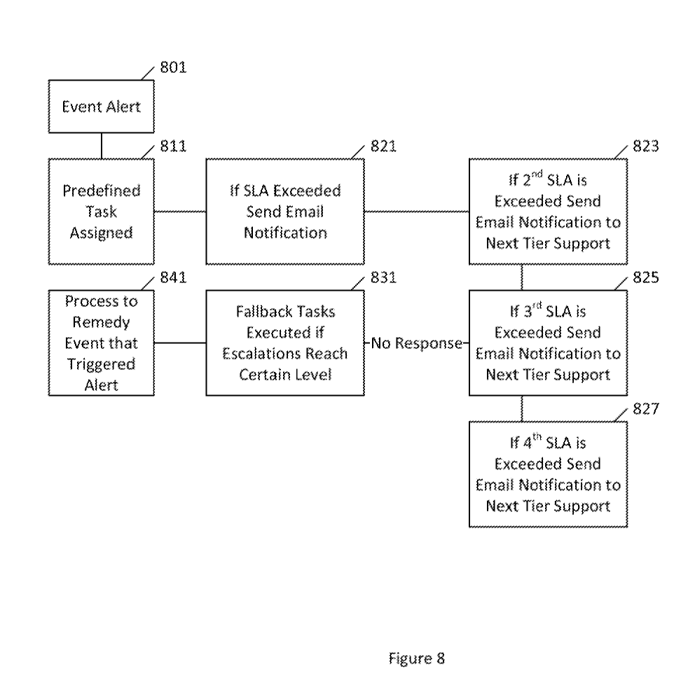

FIG. 8 illustrates escalation handling according to certain embodiments of the present invention. As shown in FIG. 8, at 801 an event alert can occur. This can be an alert generated by a system tool. A predefined task can be assigned to each team member by the system at 811. If a service level agreement (SLA) response time is exceeded at 821, an email notification can be send to a team member. In other words, if the assigned task is not addressed or completed within a first level window of time, an email notification can be generated. At 823, after a second SLA expiration, a second email notification can be sent, to a next tier of support. After a third SLA expiration at 825, a third email notification can be generated and, at 831, a fallback task can be executed to prevent further issues from arising due to the event that generated the original alert. This may lead to a process at 841 that remedies the event that triggered the alert. For example, the fallback process may be executed, which may stop or delay further damage within an affected network. Meanwhile, in parallel, at 827, if a fourth SLA expires, yet a further email can be sent to yet another tier of support.

Email is simply one example of notifications. Other electronic notifications, such as messages pushed to a smart phone, or badges or the like displayed on a tablet or other portable electronic device are also permitted.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. An apparatus, comprising:
at least one processor; and
at least one memory including computer program code,
wherein the at least one memory and the computer program code are configured to, with the at least one processor, cause the apparatus at least to
monitor an incident;
determine whether each of a plurality of incident response team members is checked in with respect to the incident; and
maintain a set of task lists and role type assignments based on the determination.

2. The apparatus of claim 1, wherein the at least one memory and the computer program code are also configured to, with the at least one processor, cause the apparatus at least to maintain the set of task lists and role type assignments in an original form when it is determined that all team members are checked in with respect to the incident.

3. The apparatus of claim 1, wherein the at least one memory and the computer program code are also configured to, with the at least one processor, cause the apparatus at least to update a command hierarchy when at least one of the plurality of incident response team members is determined not to be checked in.

4. The apparatus of claim 1, wherein the at least one memory and the computer program code are also configured to, with the at least one processor, cause the apparatus at least to adjust at least one role type for at least one team member of the plurality of incident response team members when at least one other team member of the plurality of incident response team members is determined not to be checked in.

5. The apparatus of claim 1, wherein the at least one memory and the computer program code are also configured to, with the at least one processor, cause the apparatus at least to reassign a task list from at least one team member of the plurality of incident response team members to another team member of the plurality of incident response team members when the at least one team member of the plurality of incident response team members is determined not to be checked in.

6. The apparatus of claim 5, wherein the reassignment is based on an updated role type of the another team member.

7. The apparatus of claim 1, wherein the at least one memory and the computer program code are also configured to, with the at least one processor, cause the apparatus at least to communicate with the plurality of incident response team members based on the set of task lists and role type assignments.

8. A method, comprising:
monitoring, by a computer system, an incident;
determining, by the computer system, whether each of a plurality of incident response team members is checked in with respect to the incident; and
maintaining, by the computer system, a set of task lists and role type assignments based on the determination.

9. The method of claim 8, further comprising:
maintaining, by the computer system, the set of task lists and role type assignments in an original form when it is determined that all team members are checked in with respect to the incident.

10. The method of claim 8, further comprising:
updating, by the computer system, a command hierarchy when at least one of the plurality of incident response team members is determined not to be checked in.

11. The method of claim 8, further comprising:
adjusting, by the computer system, at least one role type for at least one team member of the plurality of incident response team members when at least one other team member of the plurality of incident response team members is determined not to be checked in.

12. The method of claim 8, further comprising:
reassigning, by the computer system, a task list from at least one team member of the plurality of incident response team members to another team member of the plurality of incident response team members when the at least one team member of the plurality of incident response team members is determined not to be checked in.

13. The method of claim 12, wherein the reassignment is based on an updated role type of the another team member.

14. The method of claim 8, further comprising:
communicating, by the computer system, with the plurality of incident response team members based on the set of task lists and role type assignments.

15. An apparatus, comprising:
at least one processor; and
at least one memory including computer program code,
wherein the at least one memory and the computer program code are configured to, with the at least one processor, cause the apparatus at least to
determine whether a first time limit for performing an assigned task is past, and when it is determined that the first time limit is past, send an electronic notification that the time limit is past;
determine whether a second time limit for performing the assigned task is past, and when it is determined that the second time limit is past, send a second notification to a first higher tier of support;
determine whether a third time limit for performing the assigned task is past, and when it is determined that the third time limit is past, send a third notification to a second higher tier of support and assign a fallback task to mitigate nonperformance of the assigned task.

16. The apparatus of claim 15, wherein the at least one memory and the computer program code are also configured to, with the at least one processor, cause the apparatus at least to determine whether a fourth time limit for performing the assigned task is past, and when it is determined that the fourth time limit is past, send a fourth notification to a third higher tier of support.

17. The apparatus of claim 16, wherein the first higher tier, the second higher tier, and the third higher tier correspond to escalation within a support hierarchy.

18. A method, comprising:
determining, by a computer system, whether a first time limit for performing an assigned task is past, and when it is determined that the first time limit is past, sending an electronic notification that the time limit is past;
determining, by the computer system, whether a second time limit for performing the assigned task is past, and when it is determined that the second time limit is past, sending a second notification to a first higher tier of support;
determining, by the computer system, whether a third time limit for performing the assigned task is past, and when it is determined that the third time limit is past, sending a third notification to a second higher tier of support and assign a fallback task to mitigate nonperformance of the assigned task.

19. The method of claim 18, further comprising:
determining whether a fourth time limit for performing the assigned task is past, and when it is determined that the fourth time limit is past, sending a fourth notification to a third higher tier of support.

20. The method of claim 19, wherein the first higher tier, the second higher tier, and the third higher tier correspond to escalation within a support hierarchy.

21. A system for guiding an incident response team member to respond to an incident comprising,
a) a computer having a processor;
b) a database coupled to the computer; and
c) a non-transitory processor-readable storage medium coupled to the computer and storing executable instructions configured to:
1) retrieve from the database a role type of the incident response team member based on the incident;
2) retrieve from the database an assigned task list of the role type;
3) notify and present to the incident response team member the assigned task list;
4) monitor a participation status of the incident response team member and update the participation status to the database;
5) monitor an incident status of the incident and update the incident status to the database; and
6) close the incident after the incident has been resolved.
